(19) United States
(12) Patent Application Publication
(10) Pub. No.: US 2002/0020312 A1
(43) Pub. Date: Feb. 21, 2002

(54) Method for controlling fountain solution in a printing press

(76) Inventor: Birger Hansson, Akarp (SE)

Correspondence Address: Steven S. Payne, 8027 Iliff Drive, Dunn Loring, VA, 22027, US

(21) Appl. No.: 09/853,584

(22) Filed: May 14, 2001

(30) Foreign Application Priority Data
May 17, 2000 (SE) 0001808-5

(51) Int. Cl. B41F 1/00; B41L 23/00; B41L 25/00

(52) U.S. Cl. 101/148

(57) ABSTRACT

Fountain solution is supplied to printing plates (2) on a plate cylinder (1) in an operating offset printing press, normally by means of a spray bar (5) containing nozzles for the fountain solution. The actual amount of the fountain solution on the printing plates is assessed by means of one or more plate sensor (8). The sensor(s) (8) will scan the print plates (2) and measure at predetermined points. The assessed values are transmitted to a control unit (9), which controls the supply of fountain solution from the spray bar to the printing plates (2).

### TECHNICAL FIELD

The present invention relates to a method for controlling the amount of fountain solution on printing plates arranged on a plate cylinder in an operating printing press.

### BACKGROUND OF THE INVENTION

In a printing press, especially but not exclusively an offset printing press, printing ink is to be supplied to the printing areas of the printing plates, whereas all other areas of the printing plates are to be covered by fountain solution (generally water-based) during the entire printing process. Due to different surface conditions on the printing plates the printing ink and the fountain solution will only adhere to the intended areas.

The supply of printing ink, with which the present invention is not concerned, is performed by means of inking units, whereas fountain solution is normally supplied by means of a spray bar with a length corresponding to the width of the printing press or the length of the printing cylinder. The spray bar usually contains spray nozzles, but other supply means are also possible. From the spray bar the fountain solution is normally transferred to the printing plates by means of one or more fountain rollers.

The amount of fountain solution provided by the nozzles of the spray bar or any other means is normally set to values predetermined for the printing press and the printing medium. It is, however, also controlled by the printer, who by an experienced eye supervises the printing plates and sees to it that finally a proper amount is supplied. However, this manual control lacks proper accuracy and cannot cope with rapid changes in the conditions. Accordingly, the printing result will not be optimal, even if the printer is extremely experienced.

By EP,A1,90 181 a method and a device for delivery of fountain solution is previously known. According to said patent application the amount of fountain solution in different zones is measured by means of an axially moveable sensor. If the amount of fountain solution is to be corrected in one of the zones a control unit will see to that more fountain solution is delivered to that zone.

### THE INVENTION

The object of obviating the above drawbacks and obtaining an optimal supply of fountain solution to the printing plates is according to the invention attained in that a plate sensor will measure repeatedly at a number of predetermined points, which points are selected manually or automatically and that points where there is a printing area on the printing plates are blocked from being selected as a point for measurement of the sensor.

Where the fountain solution is supplied contact-less by means of a spray bar provided with nozzles for the fountain solution, the individual nozzles can be controlled by the control unit for supplying the requisite amount of fountain solution with the requisite timing in relation to the values assessed by the plate sensor.

By the fact that the amount of fountain solution on the printing plates is always correct or optimal, the degree of inking can be automatically controlled. Hereby the degree of inking or the density of the print is measured during printing directly on the paper; alternatively, the ink thickness on the printing plates may be measured. The supply of ink is controlled in relation hereto, so that consistent quality control and optimal printing results are achieved.

The method according to the invention leads to savings not only in manpower but also in the consumption of fountain solution and printing ink.

### BRIEF DESCRIPTION OF THE DRAWING

The invention will be described in further detail below with reference to the accompanying drawing, in which

FIG. 1 is a schematic front view of a portion of a printing press provided with a device according to the invention and

FIG. 2 is a schematic side view of the same portion.

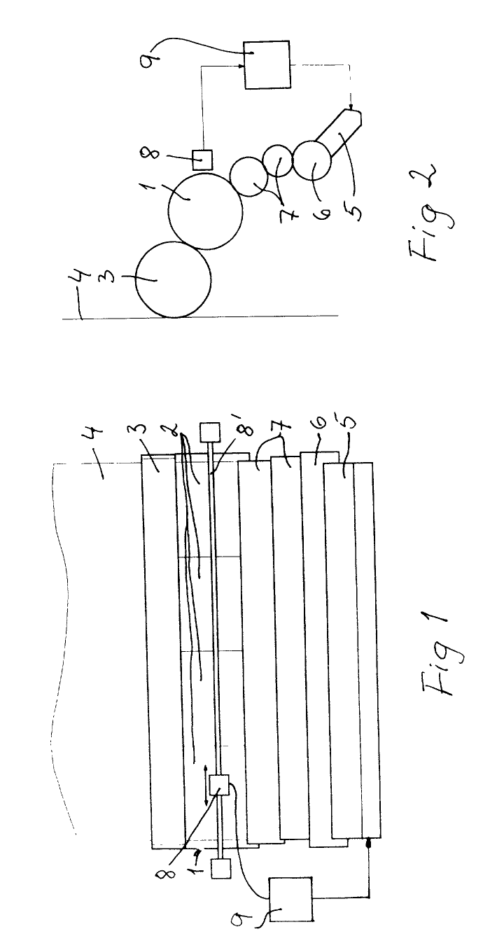

### DESCRIPTION OF PREFERRED EMBODIMENTS

A printing press, preferably but not necessarily of the offset type, is provided with a rotatable plate cylinder 1. A number of printing plates 2 are mounted on this plate cylinder 1. The printing plates may take the form of a tube attached on the plate cylinder. In the shown example the number of sets of printing plates 2 is four for printing for example four or eight newspaper pages at each revolution of the plate cylinder 1.

In contact with the plate cylinder 1 and rotating in synchronism therewith is a printing cylinder 3, which in turn is in contact with a medium 4 to be printed, normally a paper web. This medium 4 moves with the tangential speed of the printing cylinder 3.

The non-printing areas of the printing plates 2 are to be continuously covered with a layer of fountain solution, whereas only the printing areas of the plates 2 are to be provided with printing ink. This printing ink is brought to the printing plates 2 by inking units (not shown), whereas the fountain solution is brought to the plates 2 by means of a spray dampener arrangement, which as is known in the art generally consists of a spray bar 5, a fountain roller 6, and possibly one or more intermediate rollers 7 for transferring fountain solution from the spray bar 5 to the plate cylinder 1. The rollers 6 and 7 preferably rotate in synchronism with the plate cylinder 1.

For obtaining a satisfactory result, it is of outmost importance that optimal amounts of printing ink and fountain solution are provided to the printing plates 2 on the plate cylinder 1. Satisfactory results can for example be otained if the ink thickness on the plates is about 2 μm and if the fountain solution thickness is about 1 μm. The present invention is concerned with the automatic provision of fountain solution in an optimal quantity to the printing plates 2 for avoiding the present procedure of relying on the knowledge of the printer to make the proper setting of the supply of fountain solution from the spray bar 5.

For this purpose a plate sensor 8 for assessing the amount of fountain solution is arranged in comparatively close proximity to the printing plates 2 on the plate cylinder 1. In the shown example the plate sensor 8 is axially movably mounted on a guide 8′ extending in parallel with the plate cylinder 1 for scanning the printing plates.

In an alternative embodiment several sensors are placed fixed on the guide or any other support. The number of sensors may vary depending on the accuracy wanted. The more sensors the more accurate control. The sensors are arranged in comparatively close proximity to the printing plates. In a further alternative embodiment two or more sensors are arranged moveable on the guide.

The readings from the sensors 8 are supplied to an electronic control unit 9, which controls the supply of fountain solution from the spray bar 5, so that a proper amount of fountain solution is transferred via the rollers 6 and 7. Alternatively, fountain solution may also in certain constructions be transferred via the inking units.

A conventional spray bar for a printing press contains a number of fountain solution nozzles in a row. In this case the amount of fountain solution to be transferred to the plate cylinder is determined by proper control of these nozzles (in a way to be described below).

However, there are other designs for contact-less spray bars, for example equipped with brush devices or ultra-sonic equipment, and the invention is equally applicable to such designs.

The sensor(s) 8 for measuring the amount of fountain solution on the plate cylinder 1 or rather the printing plates 2 arranged thereon can work according to different principles or have different designs, and the invention is not confined to any of these principles or designs. It is for example possible to assess the amount of fountain solution by reflexion methods, and IR-light, isotopes and the like may be used.

The readings from each sensor 8 can—depending on the actual design chosen—be indicative in a rather detailed way for the amount of fountain solution on the printing plates 2 both in the axial and the circumferential direction of the plate cylinder 1, and the control of the supply and distribution of fountain solution from the spray bar 5 can be correspondingly detailed.

The control unit 9 may be the computer for the entire printing press, and there may be an alarm function therein to alert the printer and/or stop the printing press, if something in the system goes wrong.

At start-up a number of points of the printing plates 2 are measured in a matrix form by the sensor or sensors 8. The number of points in the matrix may be selected in a wide range depending on the accuracy wanted. When the measurements of the points of the matrix are analysed the points where there is ink and no fountain solution are to be discarded. The respond picked up by each sensor 8 is markedly different for ink and fountain solution. Of the points that are not discarded a number of points of the matrix are selected for repeated scanning. The selection of points may be done manually or automatically to cover all the interesting parts of the printing plates 2.

When used in connection with measurements, the expression “point” may according to this description also cover the average of a series of points at one axial position for each sensor 8.

Each sensor 8 may measure the thickness of fountain solution or just changes of the thickness. The locations of the points in the matrix are related to a specific point on the periphery of the plate cylinder 1 or the periphery of the printing plates 2. The axial location is referred to the position of the sensor 8 on the guide 8′ or each sensor if fixed sensors are used.

If the measurements indicate that further fountain solution is needed at any point the control unit 9 will increase the deliver of fountain solution at the appropriate positions. The amount of fountain solution supplied can for example be controlled in that each individual nozzle in the spray bar 5 is made to be opened and closed in a pulsating manner so as to supply a proper amount of liquid for obtaining a correct amount of fountain solution on the printing plates as assessed by the sensor or sensors 8. The obtained control is of the type closed loop. All the factors in the pulsation can be controlled, such as frequency, timings, nozzle setting, etc. Also the admission of air to the nozzles can be used as a controlling means. Each nozzle covers an area that also is partly covered by the adjacent nozzles. Thus, several nozzles have to be controlled when the amount of fountain solution is to be altered in a location. The location in which the fountain solution is delivered is often a band along the circumference of the plate cylinder 1 and not any specific point.

In the case where the amount of fountain solution still is not sufficient after an increased delivery the delivery will be increased further and/or a warning will be given to the printer. If the lack of fountain solution is very severe the control unit 9 may stop the printing process. The same may apply if there is too much fountain solution. Before the printer is alerted or the printing process is stopped a number of measurements may be done at the actual point.

For the moveable sensor the measurements are started in a first axial position of the sensor 8, in which position all the selected points will be measured. Then the sensor will move to a new axial position measuring a new set of selected points in that axial position. This will be repeated until all the selected points have been measured. Then the sensor will go back to the first axial position and repeat the measurements as stated above. Thus, the separate points are not measured on each turn of the plate cylinder. If two or more sensors 8 are arranged on the guide 8′, each sensor 8 will only move along a part of the guide 8′ and make measurements as stated above.

For the embodiment with several fixed sensors the sensors are fixed in all the desired axial positions of the matrix. By using a number of fixed sensors the speed of measurements may be increased, i.e. each selected point on the printing plates 2 will be measured at shorter intervals.

The measurement of each point is given to the control unit 9 where it is analysed to see if it is within the set tolerance. If only changes of thickness of the fountain solution is measured by the sensor 8, the last measurement will be compared to the previously recorded measurements at said point. Based on the measurements the control unit may increase or decrease the delivery of fountain solution.

The control unit 9 will take a number of factors into consideration when controlling the delivery of fountain solution. Such factors may be the pulse rate of delivery of fountain solution, the speed of the press, the paper quality and the conditions of the environment in order to control the delivery of fountain solution etc.

A person skilled in the art realises that the control unit may be placed in any suitable position, such as in or at the sensor 8 or the spray bar 5. As stated above the control unit may also be the computer for the entire printing press.

1. A method of controlling the amount of fountain solution on printing plates (2) arranged on a plate cylinder (1) in an operating printing press, comprising one or more plate sensor (8) and a control unit (9) receiving signals from the sensor(s) (8) and controlling the delivery of fountain solution, characterized in that each plate sensor (8) will measure repeatedly at a number of predetermined points, which points are selected manually or automatically and that points where there is a printing area on the printing plates (2) are blocked from being selected as a point for measurement of the sensor(s) (8).

2. The method of claim 1, characterized in that the variation of thickness of fountain solution on the printing plates (2) is measured.

3. The method of claim 1, characterized in that the thickness of the fountain solution on the printing plates (2) is measured.

4. The method of any of the previous claims, characterized in that the control unit (9) will consider the pulse rate of delivery of fountain solution, the speed of the press, the paper quality and the conditions of the environment in order to control the delivery of fountain solution.

5. The method of any of the previous claims, characterized in that the points for measurement on the printing plate are defined in relation to a specific position of the printing cylinder.

6. The method of any of the claims 1 to 4, characterized in that the points for measurement on the printing plates are defined in relation to a specific position of the printing plates.

7. The method of any of the previous claims characterized in that the fountain solution is delivered by means of spray nozzles and one or more rollers (7) and that the nozzles are controlled separately to give the desired total amount of fountain solution at a specific location.

8. The method of any of the previous claims, characterized in that the points to be blocked from selection for measurement are blocked when the control unit (9) by means of the sensor(s) (8) detect that the point is placed in a printing area.

9. The method of any of the previous claims, characterized in that in a set-up stage a number of points (matrix) are measured of which points a reduced number is selected for repeated scanning.

10. The method of any of the previous claims, characterized in that the control unit (9) will give a warning or stop the printing process if a severe divergence from the desired value is measured.

11. The method of any of the previous claims, characterized in that one or more plate sensor (8) moves to and fro in close proximity over the printing plates (2) on the plate cylinder (1) in the axial direction of the latter.

12. The method of any of the previous claims, characterized in that two or more sensors (8) are fixed in close proximity over the printing plates (2) on the plate cylinder (1).
